(19) United States
(12) Patent Application Publication
(10) Pub. No.: US 2012/0161036 A1
(43) Pub. Date: Jun. 28, 2012

(54) TESTING DEVICE FOR AMBIENT LIGHT SENSOR

(75) Inventors: SHU-SHENG PENG, Shenzhen City (CN); JIAN LI, Shenzhen City (CN); LI-JUN SHEN, Shenzhen City (CN); HUI-HUA ZHAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/213,264

(22) Filed: Aug. 19, 2011

(30) Foreign Application Priority Data
Dec. 27, 2010 (CN) 201010607203.9

(51) Int. Cl. G01N 21/01

(52) U.S. Cl. 250/491.1

(57) ABSTRACT

A testing device includes a testing platform, a testing light source, a cover plate, a control circuit board, a probe and an adapter circuit board. The testing platform defines a receiving portion. The testing light source is positioned on the testing platform and opposite to the receiving portion. The cover plate is rotatably connected to the testing platform. The control circuit board is positioned on the testing platform. The probe and the adapter circuit board are positioned on the cover plate. The adapter circuit board is electrically connecting the probe to the control circuit board.

### BACKGROUND

1. Technical Field

The present disclosure generally relates to testing devices, and particularly, to a testing device for testing ambient light sensors.

2. Description of the Related Art

To allow consumers to be able to view a display of an electronic device in different lightings, the electronic device is generally equipped with an internal ambient light sensor. The ambient light sensor can sense the light intensity of the external environment, and produce a corresponding light intensity signal that is transmitted to a processor of the electronic device. The processor adjusts the brightness of the display according to the light intensity signal, so that consumers is able to obtain a better viewing experience. Moreover, the display brightness adjustments according to the light intensity of the external environment can also reduce the power consumption of the electronic device. The ambient light sensor needs to be tested before being positioned into the electronic device, to ensure that it can work properly.

However, present conventional testing devices for the ambient light sensor typically occupy a larger volume with more complex structure, and have higher manufacturing costs.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a testing device for ambient light sensors including a base, a plurality of support poles, a testing platform, a cover plate, a testing light source, an adapter circuit board, a control circuit board, and a probe.

FIG. 2 is similar to FIG. 1, but the cover plate is covering on the testing platform.

FIG. 3 is a partial, isometric view of the testing device of FIG. 1 without the base and the support poles.

### DETAILED DESCRIPTION

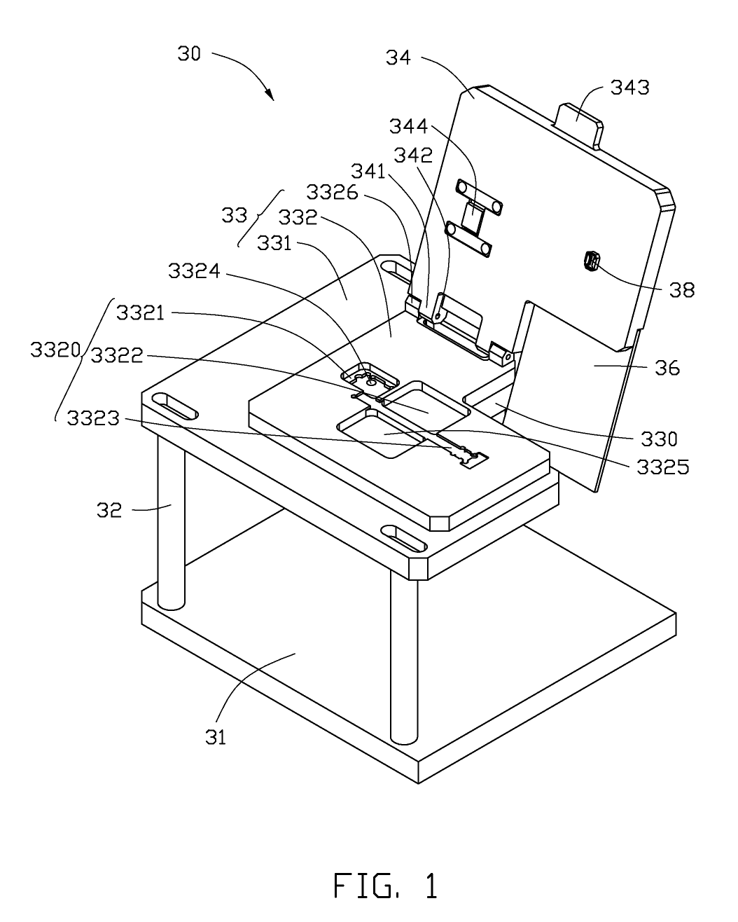

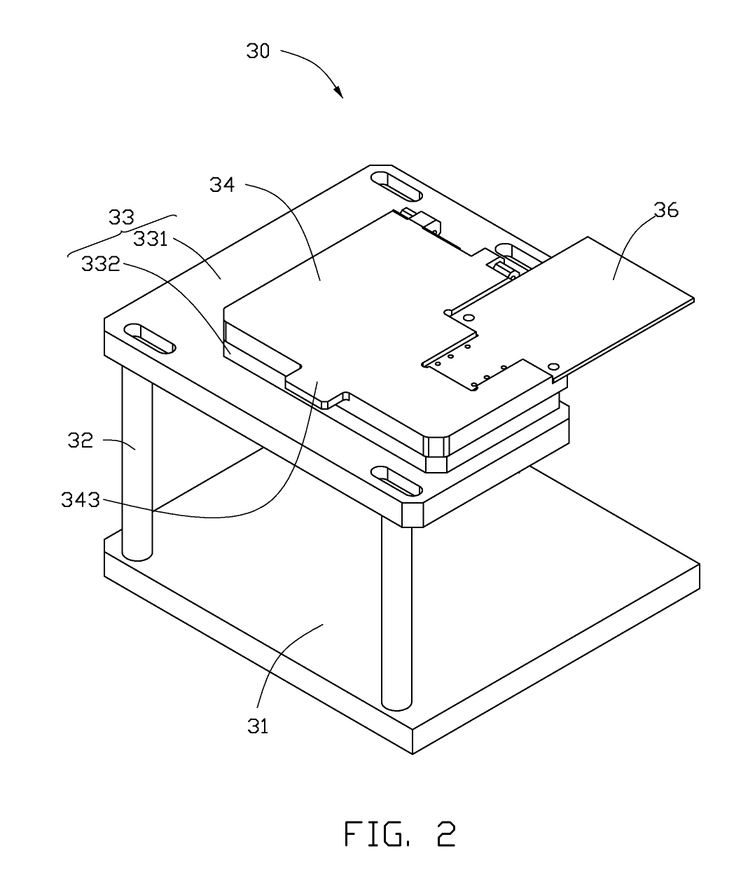

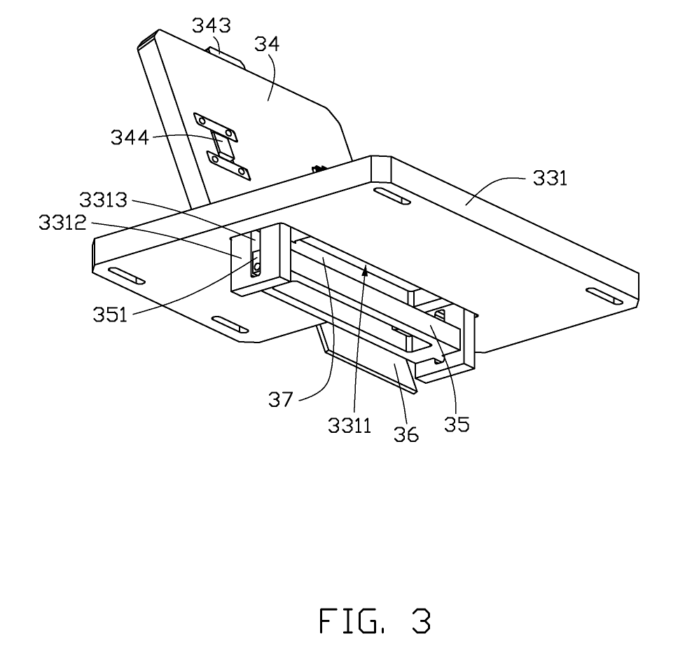

Referring to the FIGS. 1 through 3, an embodiment of a testing device 30 includes a base 31, a plurality of support poles 32, a testing platform 33, a cover plate 34, a testing light source 35, an adapter circuit board 36, a control circuit board 37, and a probe 38. The testing platform 33 is connected to the base 31 via the support poles 32. The cover plate 34 is rotatably connected to the testing platform 33. The testing light source 35 and the control circuit board 37 are positioned on the testing platform 33. The adapter circuit board 36 and the probe 38 are positioned on the cover plate 34. In the illustrated embodiment, the base 31 is a substantially rectangular plate.

The testing platform 33 defines an avoidance groove 330 in a corner thereof, and includes a support plate 331 and a testing plate 332 positioned on the support plate 331.

The support plate 331 defines a light-transmitting groove 3311 in a center thereof. Two positioning brackets 3312 are connected to the support plate 331, and adjacent to the opposite ends of the light-transmitting groove 3311, respectively. Each positioning bracket 3312 defines a sliding groove 3313.

The testing plate 332 forms a receiving portion 3320 for receiving an ambient light sensor (not shown) to be tested. In the illustrated embodiment, the receiving portion 3320 includes a first receiving groove 3321, a second receiving groove 3322 communicating with the first receiving groove 3321, and a third receiving groove 3323 communicating with the second receiving groove 3322. The first receiving groove 3321 and the second receiving groove 3322 are substantially rectangular, and the third receiving groove 3323 is substantially T-shaped. It should be pointed out that the receiving portion 3320 can be designed to any shape according to the ambient light sensor to be tested. A bottom wall in the first receiving groove 3321 defines a light penetrating hole 3324 penetrating through the testing plate 332. The light penetrating hole 3324 communicates with the light transmitting groove 3311 of the support plate 331. The testing plate 332 defines an assembly groove 3325 adjacent to the second receiving groove 3322, and the assembly groove 3325 has a depth deeper than that of the second receiving groove 3322 for allowing conveniently assembling the ambient light sensor. The testing plate 332 further forms two connecting portions 3326 disposed opposite to each other at a side adjacent to the avoidance groove 330.

The testing light source 35 forms two positioning portions 351 on opposite ends thereof. Each positioning portion 351 is slidably engaged in one corresponding sliding groove 3313 of the positioning bracket 3312, so as to adjust a distance from the testing light source 35 to the light transmitting groove 3311. In the illustrated embodiment, the testing light source 35 is a light-emitting diode (LED).

The control circuit board 37 is positioned on the support plate 331 and at one side of the testing light source 35. The control circuit board 37 is electrically connected to the testing light source 35.

The cover plate 34 forms two rotary portions 341 opposite to each other at a first end thereof. The rotary portions 341 are rotatably connected to the connecting portions 3326 of the testing plate 332 via a pivot shaft 342. The cover plate 34 also forms an operating portion 343 at a second end opposite to the first end thereof, such that the cover plate 34 can be easily rotated. An elastic member 344 is fixed to a middle portion of the cover plate 34, such that the elastic member 344 tightly presses against the ambient light sensor, when the cover plate 34 covers on the testing platform 33.

The probe 38 is assembled on a middle portion of the cover plate 34 and aligned with the elastic member 344. When the cover plate 34 is covered on the testing plate 332, the probe 38 is electrically connected to the ambient light sensor.

The adapter circuit board 36 is positioned on the cover plate 34, and electrically connected to the probe 38. The adapter circuit board 36 is also electrically connected to the control circuit board 37 via an electrical wire (not shown).

In use, the ambient light sensor is positioned in the receiving portion 3320 of the testing plate 332. The cover plate 34 is rotated to cover the testing plate 332. Then, the probe 38 is electrically connected to the ambient light sensor, and the elastic member 344 tightly presses against the ambient light sensor. The distance from the testing light source 35 to the light transmitting groove 3311 is adjusted to be equal to a predetermined distance, and the testing of the ambient light sensor is then started. Light emitted by the testing light source 35 is transmitted to the receiving portion 3320 through the light transmitting groove 3311 and the light penetrating hole 3324. The ambient light sensor is tested under three brightness modes, namely, low brightness, normal brightness, and high brightness, which are adjusted by the testing light source 35. The probe 38 obtains a plurality of testing messages regarding the ambient light sensor, and generates a testing signal. The testing signal is transmitted to the control circuit board 37 via the adapter circuit board 36. The control circuit board 37 analyzes the testing signal to determine whether the ambient light sensor is working properly. After testing, the cover plate 34 is rotated to uncover the testing plate 332, and the ambient light sensor is taken out of the receiving portion 3320 through the assembly groove 3325.

The testing device 30 utilizes the testing platform 33 and the cover plate 34 to form the testing space, and the testing signal is transmitted from the probe 38 to the control circuit board 37 via the adapter circuit board 36. Therefore, the testing device 30 has a simpler structure and a relatively lower manufacturing cost.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A testing device, comprising:
a testing platform defining a receiving portion;
a testing light source positioned on the testing platform and opposite to the receiving portion;
a cover plate rotatably connected to the testing platform;
a control circuit board positioned on the testing platform;
a probe positioned on the cover plate; and
an adapter circuit board positioned on the cover plate, and electrically connecting the probe to the control circuit board.

2. The testing device of claim 1, wherein the testing platform comprises a support plate, and a testing plate positioned on the support plate.

3. The testing device of claim 2, wherein the receiving portion is defined in the testing plate, and includes a first receiving groove, a second receiving groove communicating with the first receiving groove, and a third receiving groove communicating with the second receiving groove.

4. The testing device of claim 3, wherein the testing plate further defines an assembly groove adjacent to the second receiving groove, and the assembly groove has a depth larger than that of the second receiving groove.

5. The testing device of claim 2, further comprising a base and a plurality of support poles, wherein the testing platform is connected to the base via the support poles.

6. The testing device of claim 2, wherein the testing plate forms two connecting portions opposite to each other, and the cover plate forms two rotary portions opposite to each other; the rotary portions are rotatably connected to the connecting portions via a via a pivot shaft.

7. The testing device of claim 2, wherein a bottom wall of the receiving portion defines a light penetrating hole penetrating through the testing plate.

8. The testing device of claim 7, wherein the support plate defines a light transmitting groove communicating with the light penetrating hole of the testing plate.

9. The testing device of claim 8, wherein two positioning brackets are connected to the support plate, and adjacent to opposite ends of the light transmitting groove respectively, each positioning bracket defines a sliding groove; the testing light source form two positioning portions on opposite ends, and the positioning portions are slidably engaged in the sliding grooves of the positioning bracket.

10. The testing device of claim 1, wherein an elastic member is positioned on the cover plate and opposite to the receiving portion.

11. A testing device, comprising:
a testing platform;
a cover plate rotatably connected to the testing platform, and the cover plate and the testing platform cooperatively defining a testing space;
a testing light source positioned on the testing platform and providing light in the testing space;
a control circuit board positioned on the testing platform; and
a probe positioned on the cover plate and electrically connected to the control circuit board.

12. The testing device of claim 11, wherein the testing platform comprises a support plate, and a testing plate positioned on the support plate.

13. The testing device of claim 12, wherein the receiving portion is defined in the testing plate, and includes a first receiving groove, a second receiving groove communicating with the first receiving groove, and a third receiving groove communicating with the second receiving groove.

14. The testing device of claim 13, wherein the testing plate further defines an assembly groove adjacent to the second receiving groove, and the assembly groove has a depth larger than that of the second receiving groove.

15. The testing device of claim 12, further comprising a base and a plurality of support poles, wherein the testing platform is connected to the base via the support poles.

16. The testing device of claim 12, wherein the testing plate forms two connecting portions opposite to each other, and the cover plate forms two rotary portions opposite to each other; the rotary portions are rotatably connected to the connecting portions via a via a pivot shaft.

17. The testing device of claim 12, wherein a bottom wall of the receiving portion defines a light penetrating hole penetrating through the testing plate.

18. The testing device of claim 17, wherein the support plate defines a light transmitting groove communicating with the light penetrating hole of the testing plate.

19. The testing device of claim 18, wherein two positioning brackets are connected to the support plate, and adjacent to opposite ends of the light transmitting groove respectively, each positioning bracket defines a sliding groove; the testing light source form two positioning portions on opposite ends, and the positioning portions are slidably engaged in the sliding grooves of the positioning bracket.

20. The testing device of claim 11, wherein an elastic member is positioned on the cover plate and opposite to the receiving portion.
